(19) United States
(12) Patent Application Publication
(10) Pub. No.: US 2020/0168052 A1
(43) Pub. Date: May 28, 2020

(54) METHOD AND SYSTEM FOR WAGERING ON SPORTING EVENTS

(71) Applicant: Equilottery LLC, Louisville, KY (US)

(72) Inventor: Bradford T. Cummings, Louisville, KY (US)

(21) Appl. No.: 16/779,138

(22) Filed: Jan. 31, 2020

Related U.S. Application Data
(63) Continuation of application No. 15/922,606, filed on Mar. 15, 2018.
Application No. 15/922,606 is a continuation-in-part of application No. 15/079,360, filed on Mar. 24, 2016, now abandoned.
(60) Provisional application No. 62/479,765, filed on Mar. 31, 2017.

(51) Int. Cl. G07F 17/32; G06F 7/58; G06Q 50/34

(52) U.S. Cl. CPC G07F 17/3288; G06Q 50/34; G06F 7/58; G07F 17/3258

(57) ABSTRACT

In a method and system for wagering on sporting events, a ticket is generated at a point-of-purchase terminal that includes a series of numbers (or symbols), with each number (or symbol) corresponding to a selected outcome of one or more sporting events. A first portion of the purchase price of the ticket is treated as a wager, which is placed with a sportsbook. Another portion of the purchase price is allocated to a progressive pool. After occurrence of the one or more sporting events results in a series of winning outcomes, a determination is made as to whether the series of numbers (or symbols) on the ticket matches the series of winning outcomes, and if so, a determination is made as to an amount of a payout from the wager. Furthermore, a determination is also made as to whether the player qualifies for a progressive payout from the progressive pool.

### CROSS-REFERENCE TO RELATED APPLICATIONS

The present application is a continuation of U.S. patent application Ser. No. 15/922,606 filed on Mar. 15, 2018, which claims priority to U.S. patent application Ser. No. 62/479,765 filed on Mar. 31, 2017 and is a continuation-in-part of U.S. patent application Ser. No. 15/079,360 filed on Mar. 24, 2016, the entire disclosures of which are incorporated herein by reference.

### BACKGROUND OF THE INVENTION

The present invention is a method and system for wagering on sporting events.

Wagering on sporting events continues to be a popular form of gambling. A sportsbook is an entity that functions as a “market maker” for wagering on sporting events. The sportsbook accepts wagers on potential outcomes of a sporting event, paying winning wagers based on established odds for each outcome.

Lottery games are another common and popular form of gambling in which the winners are determined in some random manner. In a lottery game, point-of-purchase terminals for purchasing tickets are commonly found in grocery stores, convenience stores, gas stations, and other retail locations. Each player may purchase a ticket with a player-selected or randomly generated series of numbers. If that series of numbers, or a portion of that series, is selected in a subsequent random drawing or selection of numbers, the player wins a cash amount that may be fixed or may be determined as a percentage of the receipts from tickets for that particular drawing. For another example, instant lottery tickets provide a player the opportunity to win a cash amount (or another prize) without waiting for a subsequent drawing. Specifically, an instant lottery ticket generally includes winning (or losing) numbers or icons that are concealed on the ticket itself. The numbers or icons are typically hidden by a coating. By removing this coating, the player can instantly determine whether or not it is a winning ticket rather than waiting for a subsequent drawing.

U.S. patent application Ser. No. 15/079,360, which is incorporated herein by reference, describes a method and system for wagering on sporting events, in which multiple point-of-purchase terminals are provided at grocery stores, convenience stores, gas stations, and other retail locations. Each such point-of-purchase terminal generally comprises a computer with one or more input means, such as a keyboard, mouse, touch screen, etc. Using such point-of-purchase terminals, a ticket can be purchased in the same manner that current lottery tickets are purchased.

As described in U.S. patent application Ser. No. 15/079,360, each ticket includes a series of player-selected numbers (or other alphanumeric characters or symbols) or a series of randomly generated numbers (or other alphanumeric characters or symbols). Each number is assigned to the outcome of a sporting event, including, for example, but not limited to, football games, baseball games, basketball games, hockey games, soccer matches, and horse races. A number could be associated with any potential outcome of a sporting event, including straight-up bets, bets against a point spread, or various proposition (“prop”) bets. For example, with respect to prop bets, for some popular sporting events, it is possible to place wagers on such events as the length of the rendition of the national anthem (over/under), the outcome of the coin toss (heads/tails), the highest scoring quarter or time period (multiple choice), whether a particular back-up or reserve player enters the game (yes/no), or the occurrence of certain unusual plays.

Each of the point-of-purchase terminals is in communication with a first computer server and associated database to record the purchase of each ticket. The first computer server is then in communication with another (or second) computer server and associated database that is hosted by a sportsbook.

When a ticket is purchased, a predetermined portion of the purchase price is treated as a wager and allocated to the sportsbook. Accordingly, the first computer server communicates with the second computer server hosted by the sportsbook and records the wager.

The remainder of the purchase price is then allocated into other pools, including, in at least some implementations, a secondary payout pool. For example, the secondary payout pool may be used to provide some form of consolation prizes, or it may be used to supplement winning payouts.

At some future date, the outcomes of the sporting events will determine a winning series of numbers. If a player has a matching ticket, i.e., the series of user-selected or randomly generated numbers on the ticket matches the winning series of numbers from the outcomes of the sporting events, the player is a winner and is entitled to a payout. The amount of the payout is then determined by the amount generated by the wager placed with the sportsbook. In this regard, the amount generated by the wager with the sportsbook is calculated by the second computer server hosted by the sportsbook and communicated back to the first computer server.

As described in U.S. patent application Ser. No. 15/079,360, in those implementations in which the secondary payout pool is accessed to pay consolation prizes, at the time the winner is determined, the first server is also used to make such a determination about consolation prizes.

As described in U.S. patent application Ser. No. 15/079,360, in those implementations in which the secondary payout pool is used to supplement winning payouts, a determination is made by the first computer server as to whether the payout amount (preliminary amount) exceeds a predetermined minimum amount. If not, the secondary payout pool is accessed to make up the difference, and the predetermined minimum amount is treated as the final payout and awarded to the player.

It would be desirable to improve upon the combination of a lottery game with wagering on sporting events as described in U.S. patent application Ser. No. 15/079,360 to further increase the excitement of the game, but without unduly increasing the complexity of the game.

### SUMMARY OF THE INVENTION

The present invention is a method and system for wagering on sporting events.

In an exemplary implementation of the method and system of the present invention, multiple point-of-purchase terminals are provided at various retail locations, including, for example, grocery stores, convenience marts, and gas stations. Using such point-of-purchase terminals, a ticket can be purchased in the same manner that current lottery tickets are purchased. Alternatively, such point-of-purchase terminals could be in the form of user devices, such as a smartphone, tablet, desktop computer, or other computing device.

Irrespective of what form of point-of-purchase terminal or user device is used by a particular individual, a ticket is purchased that includes a series of player-selected numbers or a series of randomly generated numbers. Although numbers may be preferred for simplicity, any alphanumeric characters or other symbols could be used in place of numbers without departing from the spirit and scope of the present invention.

Whether a ticket includes a series of player-selected numbers or a series of randomly generated numbers, each number is assigned to an outcome of a sporting event.

Each of the point-of-purchase terminals and/or each of the user devices is in communication with a first computer server and associated database to record the purchase of each ticket. The first computer server is then in communication with another (or second) computer server and associated database that is hosted by a sportsbook. As defined above and as used in the present application, a sportsbook is an entity that functions as a “market maker” for wagering on sporting events, i.e., it accepts wagers on sporting events and pays out winnings for successful wagers, whether that entity is associated with a physical location or operates as a virtual entity accessible via the Internet or other computer network. For example, in the context of the present application, a sportsbook could include a state lottery or other non-traditional entity that facilitates wagering on sporting events.

When a ticket is purchased by a player, a first portion of the purchase price of each ticket is treated as a wager and allocated to the sportsbook. Accordingly, the first computer server communicates with the second computer server hosted by the sportsbook and records the wager. A remainder of the purchase price of each ticket is then allocated into other pools, including a progressive pool that is established to provide an alternative source for winning payouts in certain circumstances.

At some future date, the outcomes of the one or more sporting events will determine a winning series of numbers (or other alphanumeric characters or symbols). If a player has a matching ticket, i.e., the series of user-selected or randomly generated numbers on the ticket matches (partially or completely) the winning series of numbers from the outcomes of the one or more sporting events, the player is a winner and is entitled to a payout. The amount of the payout is then determined by the amount generated by the wager (or wagers) placed with the sportsbook.

With respect to the progressive pool, this pool is intended to accumulate funds from across multiple sporting events and wagers. The funds in the progressive pool are then accessed to make payouts in extraordinary circumstances. Thus, at some future date after the outcomes of the one or more sporting events have determined a winning series of numbers, a determination is also made by the first computer server as to whether the winner also qualifies for a progressive payout, and if so, that progressive payout is also awarded to the player.

In some implementations, a portion of the purchase price is also allocated to a secondary payout pool, which can be accessed to award consolation prizes and/or to supplemental a payout when the calculated payout falls below a predetermined minimum amount.

The method and system of the present invention thus combines a lottery game with wagering on sporting events, allowing players to place wagers on sporting events by essentially buying lottery-like tickets through the point-of-purchase terminals commonly found in grocery stores, convenience stores, gas stations, and other retail locations, or via user devices.

### DESCRIPTION OF THE DRAWINGS

FIG. 1 is a schematic illustration of an exemplary implementation of the method and system of the present invention;

FIG. 2 is a diagram illustrating how the monies associated with the purchase of a ticket are allocated in an exemplary implementation of the method and system of the present invention;

FIG. 3A is a flow chart illustrating a determination of a payout for a ticket in which the monies have been allocated as in FIG. 2;

FIG. 3B is a flow chart illustrating an alternate determination of a payout for a ticket in which the monies have been allocated as in FIG. 2; and

FIG. 4 is an illustration of the contributions to a progressive pool from multiple lottery administrators and/or sportsbooks.

### DETAILED DESCRIPTION OF THE INVENTION

The present invention is a method and system for wagering on sporting events.

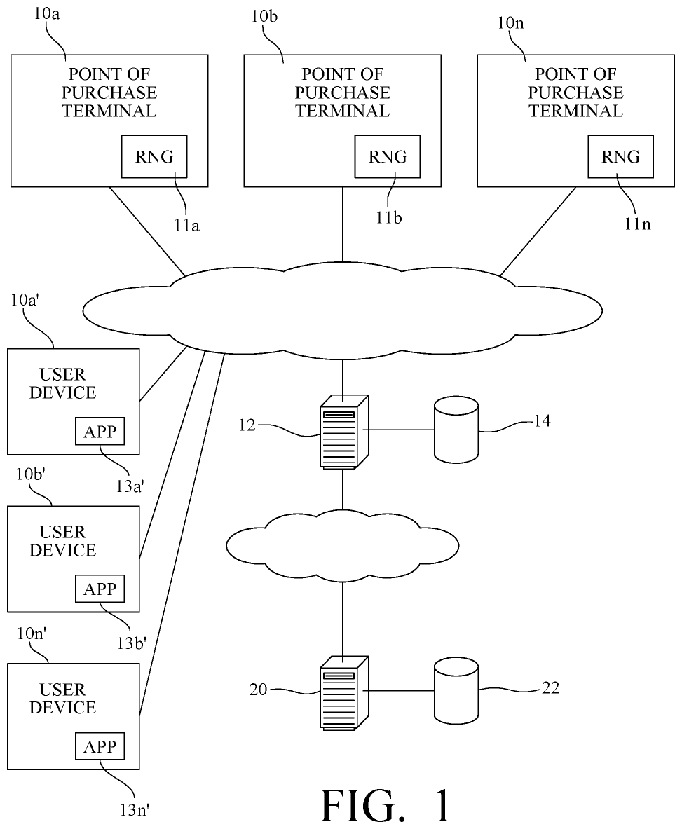

Referring now to FIG. 1, in an exemplary implementation of the method and system of the present invention, multiple point-of-purchase terminals 10a, 10b, . . . 10n are provided at various retail locations, including, for example, grocery stores, convenience marts, and gas stations. Similar to the point-of-purchase terminals that are currently used in lottery operations, each such point-of-purchase terminal 10a, 10b, . . . 10n generally comprises a computer with one or more input means, such as a keyboard, mouse, touch screen, etc. Using such point-of-purchase terminals 10a, 10b, . . . 10n, a ticket can be purchased in the same manner that current lottery tickets are purchased.

Alternatively, and as also illustrated in FIG. 1, such point-of-purchase terminals could be in the form of user devices 10a′, 10b′, . . . 10n′, such as a smartphone, tablet, desktop computer, or other computing device, each of which are running a software program 13a′, 13b′, . . . 13n′, preferably in the form of an application (or “app”). Each user device 10a′, 10b′, . . . 10n′ thus has a microprocessor, an internal memory component (e.g., a hard drive or solid-state drive), and a display screen. Alternatively, the software program 13a′, 13b′, . . . 13n′ could be a web-based application accessible through a common Internet browser.

Irrespective of what form of point-of-purchase terminal 10a′, 10b′, . . . 10n or user device 10a′, 10b′, 10n′ is used by a particular individual, a ticket is purchased that includes a series of player-selected numbers or a series of randomly generated numbers. Although numbers may be preferred for simplicity, any alphanumeric characters or other symbols could be used in place of numbers without departing from the spirit and scope of the present invention.

In certain jurisdictions, it may be necessary or desirable to allow only for the purchase of tickets with a series of randomly generated numbers (or other alphanumeric characters or symbols), similar to a “quick pick” or similar automated number selection in lottery games. In that case, the game would be more akin to a lottery, in which chance plays the predominant role in determining the outcome. With respect to randomly generated numbers, each point-of-purchase terminal 10a, 10b, . . . 10n thus includes a software-implemented random number generator (“RNG”) 11a, 11b, . . . 11n that produces a series of randomly generated numbers for the ticket. Similarly, the software program 13a′, 13b′, . . . 13n′ running on the user devices 10a′, 10b′, . . . 10n′ would include a RNG.

Whether a ticket includes a series of player-selected numbers or a series of randomly generated numbers, each number is assigned to an outcome of a sporting event. Table A is an example of the assignment of certain numbers to the outcomes of multiple sporting events. In short, a number could be associated with any potential outcome of a sporting event, including straight-up bets, bets against a point spread, or various proposition (“prop”) bets.

TABLE A

| | |
|---|---|
| 0 | New York wins over Los Angeles |
| 1 | Los Angeles wins over New York |
| 2 | New York (+2) over Los Angeles |
| 3 | Los Angeles (−2) over New York |
| 4 | Chicago wins over Houston |
| 5 | Houston wins over Chicago |
| 6 | Chicago (+2) over Houston |
| 7 | Houston (−2) over Chicago |
| 8 | Louisville wins over Cincinnati |
| 9 | Cincinnati wins over Louisville |

Again, a purchased ticket could include a series of player-selected numbers or a series of randomly generated numbers. With respect to Table A, the available numbers would be 0-9. For example, a three-number series, whether player-selected or randomly generated, could be 1-6-9 (similar to typical Pick 3 lottery game), but, in this case, would correspond to the outcomes of the three sporting events identified above in Table A. Of course, if random number generation were used to generate the ticket, in certain cases, the random number generator would have to be programmed to eliminate certain combinations. For example, with respect to Table A, a single ticket should not include numbers 0 and 1, as these represent mutually exclusive outcomes (i.e., both New York and Los Angeles could not win the same game.).

For another example, Table B illustrates another possible ticket layout and example of the assignment of certain numbers to the outcomes of multiple sporting events, which is similar to the layout of a common parlay card:

TABLE B

| | | | |
|---|---|---|---|
| 1 | DET | CHI | 2 |
| 3 | LA | NY | 4 |
| 5 | IND | BAL | 6 |
| 7 | JAX | MIA | 8 |
| 9 | CLE | NE | 10 |
| 11 | DEN | SEA | 12 |
| 13 | ARI | CAR | 14 |
| 15 | DAL | GB | 16 |
| 17 | KC | PIT | 18 |
| 19 | PHI | WAS | 20 |

Referring still to FIG. 1, each of the point-of-purchase terminals 10a, 10b, . . . 10n and/or each of the user devices 10a′, 10b′, . . . 10n′ is in communication with a first computer server 12 and associated database 14 to record the purchase of each ticket. Such communications are preferably facilitated through an Internet connection, satellite communications, or similar known means of data transport. The first computer server 12 is then in communication with another (or second) computer server 20 and associated database 22 that is hosted by a sportsbook. As defined above and as used in the present application, a sportsbook is an entity that functions as a “market maker” for wagering on sporting events, i.e., it accepts wagers on sporting events and pays out winnings for successful wagers, whether that entity is associated with a physical location or operates as a virtual entity accessible via the Internet or other computer network. For example, in the context of the present application, a sportsbook could include a state lottery or other non-traditional entity that facilitates wagering on sporting events. In any event, such communications are again preferably facilitated through an Internet connection, satellite communications, or similar known means of data transport.

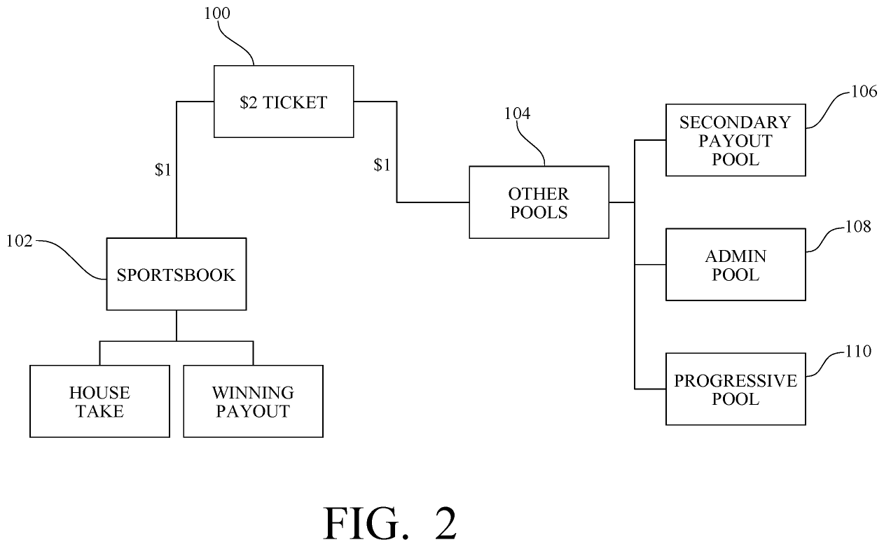

FIG. 2 is a diagram illustrating how the monies associated with the purchase of a ticket are allocated. In FIG. 2, a $2 ticket is purchased, as indicated by block 100. For sake of example, the ticket could be the three-number series 1-6-9, as discussed above. A first predetermined portion of the purchase price, in this case, one dollar ($1), is then treated as a wager and allocated to the sportsbook, as indicated by block 102. Accordingly, the first computer server 12 communicates with the second computer server 20 hosted by the sportsbook (as illustrated in FIG. 1) and records the wager, such that a $1 wager is entered for the three outcomes of the sporting events identified in Table A above. This would typically be in the form of a $1 parlay, but could also be in the form of three individual wagers.

A remainder ($1) of the purchase price is then allocated into other pools, as indicated by block 104. In this exemplary implementation, one of the other pools is a secondary payout pool 106 (SECONDARY PAYOUT POOL), which is used to provide some form of consolation prizes, or it may be used to supplement winning payouts, as further described below. Another pool 108 (ADMIN POOL) is then used for administrative expenses and/or other purposes. Finally, unlike U.S. patent application Ser. No. 15/079,360, a third pool 110 (PROGRESSIVE POOL) is established to provide an alternative source for winning payouts in certain circumstances, as further described below.

As an alternative, although not shown in FIG. 2, the player may be required to pay an additional amount to qualify for an award from the third pool 110 (PROGRESSIVE POOL). In other words, in such an alternative implementation, the player would have to pay an additional amount at the time of purchase of the ticket, which would be allocated to the third pool 110 (PROGRESSIVE POOL).

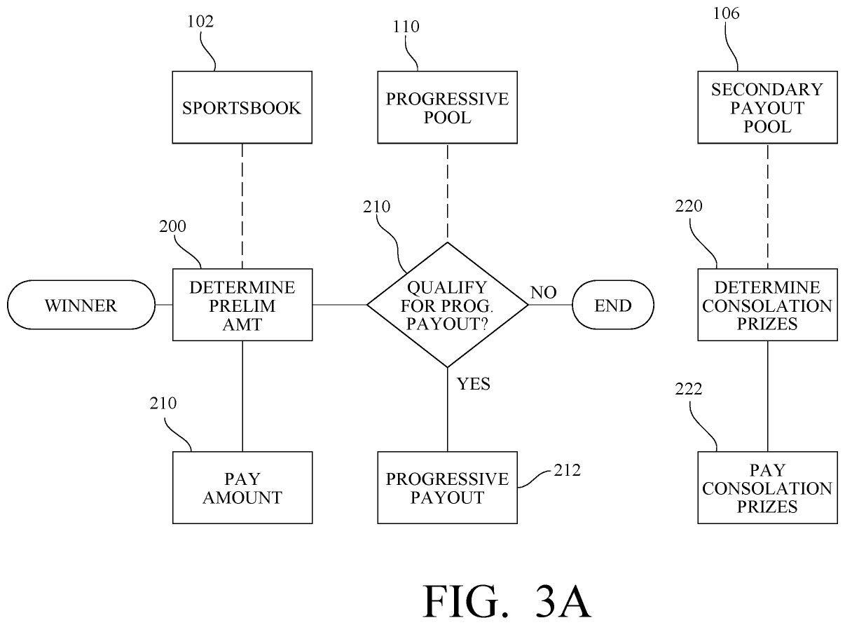

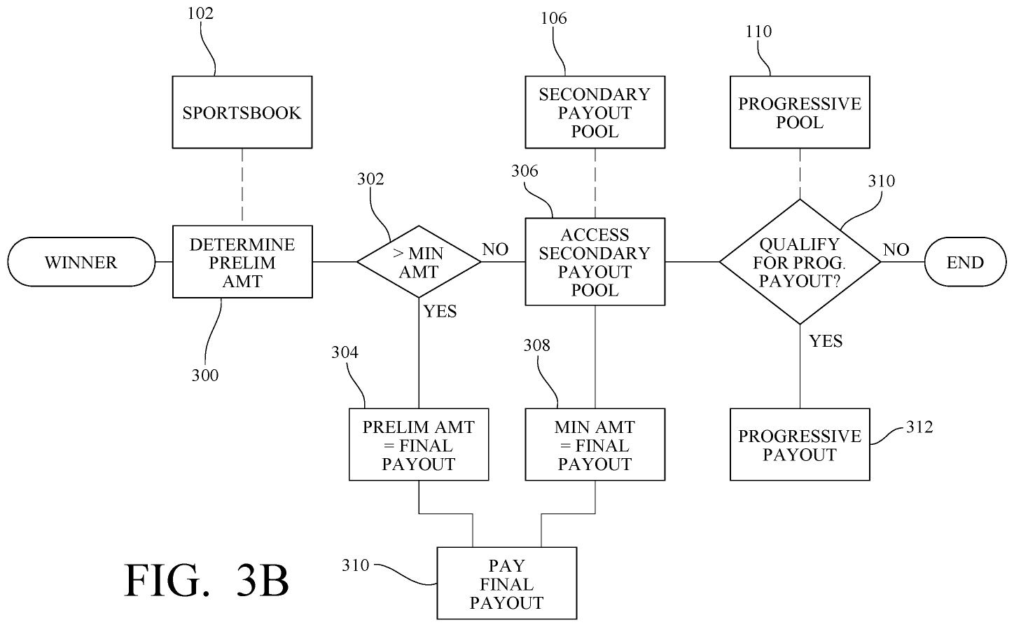

Referring now to FIG. 3A, at some future date, the outcomes of the one or more sporting events will determine a winning series of numbers (or other alphanumeric characters or symbols). If a player has a matching ticket, i.e., the series of user-selected or randomly generated numbers on the ticket matches the winning series of numbers from the outcomes of the one or more sporting events, the player is a winner and is entitled to a payout. In most cases, a player would only have a winning ticket if all numbers on the ticket matched the winning series of numbers. However, in some cases, winning tickets may include those with partial matches (as further described below).

The amount (AMOUNT) of the payout is then determined by the amount generated by the wager (or wagers) placed with the sportsbook, as indicated by block 200 of FIG. 3A. In this regard, the amount generated by the $1 wager(s) with the sportsbook is calculated by the second computer server 20 hosted by the sportsbook (including any deductions for the house take, etc.) and communicated back to the first computer server 12. In most cases, wagers on sporting events are fixed odds wagers, and the amount generated by the wager would be calculated based on the posted odds at the time of the wager. Applying the applicable odds, the amount calculated by the second computer server 20 hosted by the sportsbook is then paid to a player holding the winning ticket or set aside until the player presents the winning ticket, as indicated by block 210.

As also shown in FIG. 3A, in some implementations, at the time the winner is determined, the secondary payout pool 106 may be accessed to determine consolation prizes, as indicated by block 220. Such determination is made by the first computer server 12. The consolation prizes are then paid to players holding qualifying tickets or set aside until players present those tickets, as indicated by block 222.

With respect to accessing the secondary payout pool 106 and awarding consolation prizes, in some cases, consolation prizes would be awarded to “partial” winners based on the matching of some, but not all, numbers. For example, referring back to Table B, a consolation prize might be awarded to a player who had eight or nine games correct, but not all ten.

Now, with respect to the third pool 110 (PROGRESSIVE POOL), this third pool 110 is intended to accumulate funds from across multiple sporting events and wagers. The funds in this third pool 110 are then accessed to make payouts in extraordinary circumstances.

For example, a player may have the opportunity to purchase a series of tickets for multiple sporting events. If that player was a winner on each ticket (as described above), the player would be entitled to the payout determined according to FIG. 3A above. Furthermore, for being a winner across multiple tickets, that player would also be entitled to progressive payout (i.e., an additional prize), which would be paid from the third pool 110.

For another example, a player may be presented with additional selections on a single ticket, i.e., selections beyond which team would win each game or other standard outcomes. For instance, a player would not only have to select which team would win each game, but also would have to select the top scoring player on each team. Since there are multiple players on each team who could lead the team in scoring, this would make it much more difficult to make accurate predictions. If a player was successful in matching all winning outcomes, including such additional selections, that player would also be entitled to a progressive payout (i.e., an additional prize), which would be paid from the third pool 110.

For another example, a player may be presented with additional selections in a form of a daily fantasy sports game. Specifically, the player would select a number of actual players (i.e., participants in the one or more sporting events) to follow on a given day, with points awarded for actual performance. If a player was successful in matching all winning outcomes for the primary wager made with the sportsbook, and that player also had the highest or best performance with respect to the additional selections, that player would also be entitled to a progressive payout (i.e., an additional prize), which would be paid from the third pool 110.

Thus, and as also shown in FIG. 3A, a determination is also made by the first computer server 12 at decision 210 as to whether the winner also qualifies for a progressive payout, and if so, that progressive payout is also awarded to the player, as indicated by block 212.

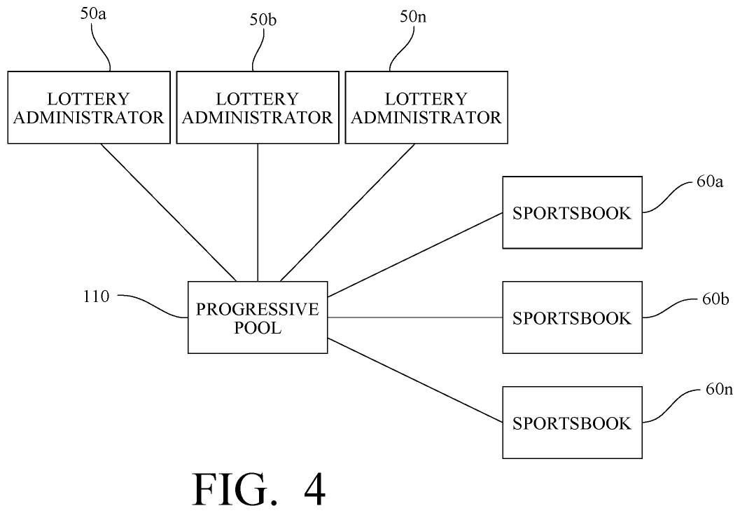

Furthermore, and referring now to FIG. 4, it is contemplated that the progressive pool 110 could be established across lottery administrators 50a, 50b, . . . 50n and/or sportsbooks 50a, 50b, . . . 50n. Thus, while only a small portion of the purchase price for each ticket may be allocated to the progressive pool 110, with multiple lottery administrators 50a, 50b, . . . 50n or sportsbooks 50a, 50b, . . . 60n contributing to the progressive pool 110, it can support larger payouts (or jackpots).

Referring now to FIG. 3B, in an alternate implementation, at some future date, the outcomes of the one or more sporting events will determine a winning series of numbers (or other alphanumeric characters or symbols). If a player has a matching ticket, i.e., the series of user-selected or randomly generated numbers on the ticket matches the winning series of numbers from the outcomes of the sporting events, the player is a winner and is entitled to a payout. As stated above, in most cases, a player would only have a winning ticket if all numbers on the ticket matched the winning series of numbers. However, in some cases, winning tickets may include those with partial matches (as further described below).

The preliminary amount (PRELIM AMT) of the payout is then determined by the amount generated by the wager (or wagers) placed with the sportsbook, as indicated by block 300 of FIG. 3B. In this regard, the amount generated by the $1 wager(s) with the sportsbook is calculated by the second computer server 20 hosted by the sportsbook (including any deductions for the house take, etc.) and communicated back to the first computer server 12. Then, a determination is made by the first computer server 12 at decision 302 as to whether this preliminary amount (PRELIM AMT) exceeds a predetermined minimum amount (MIN AMT). If so, that preliminary amount (PRELIM AMT) is treated as the final payout (FINAL PAYOUT), as indicated by block 304. If not, the secondary payout pool 106 is accessed to make up the difference, as indicated by block 306, and the predetermined minimum amount (MIN AMT) is treated as the final payout, as indicated by block 308. In either case, the final payout is then paid to a player holding the winning ticket or set aside until the player presents the winning ticket, as indicated by block 310.

Again, with respect to the third pool 110 (PROGRESSIVE POOL), for being a winner across multiple tickets or in other extraordinary circumstances, a player may also be entitled to progressive payout (i.e., an additional prize), which would be paid from the third pool 110. Thus, and as also shown in FIG. 3B, a determination is also made by the first computer server 12 at decision 310 as to whether the winner also qualifies for a progressive payout, and if so, that progressive payout is also awarded to the player, as indicated by block 312.

As mentioned above, in some cases, winning tickets may include those with partial matches. As a specific example, a sporting event may be a horse race, and the player purchases a ticket with a series of numbers that corresponds to entrants in the horse race. For instance, the horse race may include 12 entrants, and the ticket includes a series of 10 numbers (player-selected or randomly generated) in order. The winning series of numbers will be the order in which the entrants finish the horse race (i.e., the first 10 finishers). With respect to the determination of the amount (AMOUNT) of the payout (as indicated by block 200 of FIG. 3A or block 300 of FIG. 3B), the amount generated by the wager(s) with the sportsbook would be calculated based on the correspondence between the winning series of numbers of the series of numbers on the ticket. For instance, if the first number of the series of numbers on the ticket were that of the winning horse, a first payout would be made. If the first and second numbers of the series of numbers on the ticket were that of the winning and second-place horses, a second payout would be made, and so on. Each such payout would preferably be based on a fixed odds table. Furthermore, in this specific example, with respect to determination as to whether the player qualifies for a progressive payout (as indicated by decision 210 of FIG. 3A or decision 310 of FIG. 3B), the award of the progressive payout may be based on complete correspondence between the winning series of numbers of the series of numbers on the ticket, i.e., the series of numbers on the ticket reflect the correct order of the finish of all horses.

As a further refinement, with respect to the specific example presented above, if there is a scratch of one or more horses from a particular horse race, a random number generator may be used to “place” that horse into the field and into the winning series of numbers. Should a particular horse race be cancelled in its entirety, a random number generator may be used to determine the winning series of numbers.

The method and system of the present invention, as described above with reference to FIGS. 1-2, 3A, 3B, and 4, thus combines a lottery game with wagering on sporting events, allowing players to place wagers on sporting events by essentially buying lottery-like tickets through the point-of-purchase terminals commonly found in grocery stores, convenience stores, gas stations, and other retail locations, or via user devices.

One of ordinary skill in the art will recognize that additional implementations and/or embodiments are also possible without departing from the teachings of the present invention. This detailed description, and particularly the specific details of the exemplary implementations and embodiments disclosed therein, is given primarily for clarity of understanding, and no unnecessary limitations are to be understood therefrom, for modifications will become obvious to those skilled in the art upon reading this disclosure and may be made without departing from the spirit or scope of the present invention.

What is claimed is:

1. A system for wagering on one or more sporting events, comprising:
multiple point-of-purchase terminals, each such point-of-purchase terminal for generating tickets, each ticket including a series of player-selected symbols, each symbol corresponding to a selected outcome associated with the one or more sporting events, wherein each ticket is acquired by a player for a purchase price;
a first computer server in communication with the multiple point-of-purchase terminals for recording the generation of each ticket, the first computer server allocating a first portion of the purchase price of each ticket to one or more wagers on the selected outcomes, the first computer server allocating a second portion of the purchase price of each ticket to a secondary payout pool, and the first computer server allocating a third portion of the purchase price of each ticket to a progressive pool; and
a second computer server administered by a sportsbook for managing the one or more wagers, the second computer server in communication with the first computer server, and the second computer server receiving and recording the one or more wagers;
wherein, after occurrence of the one or more sporting events results in a series of winning outcomes, the first computer server (i) determines whether the series of player-selected symbols on each ticket matches the series of winning outcomes, and if so, determines an amount of a payout from the one or more wagers via communication with the second computer server that manages the one or more wagers, and (ii) if the series of player-selected symbols on each ticket matches the series of winning outcomes, also determines whether the player further qualifies for a progressive payout from the progressive pool.

2. The system as recited in claim 1, wherein, after occurrence of the one or more sporting events results in the series of winning outcomes, the first computer server also (iii) determines whether any consolation prizes are to be awarded, and if so, accesses the secondary payout pool to pay such consolation prizes.

3. The system as recited in claim 1, wherein, after occurrence of the one or more sporting events results in the series of winning outcomes, the first computer server also (iii) determines whether the amount of the payout from the one or more wagers exceeds a predetermined minimum amount, and if not, uses the secondary payout pool to supplement the payout from the one or more wagers, resulting in a final payout.

4. The system as recited in claim 1, wherein the symbols are alphanumeric characters.

5. The system as recited in claim 1, wherein the symbols are numbers. A system for wagering on one or more sporting events, comprising:
multiple point-of-purchase terminals, each such point-of-purchase terminal for generating tickets, each ticket including a series of randomly generated symbols, each symbol corresponding to a selected outcome associated with the one or more sporting events, wherein each ticket is acquired by a player for a purchase price;
a first computer server in communication with the multiple point-of-purchase terminals for recording the generation of each ticket, the first computer server allocating a first portion of the purchase price of each ticket to one or more wagers on the selected outcomes, the first computer server allocating a second portion of the purchase price of each ticket to a secondary payout pool, and the first computer server allocating a third portion of the purchase price of each ticket to a progressive pool; and
a second computer server administered by a sportsbook for managing the one or more wagers, the second computer server in communication with the first computer server, and the second computer server receiving and recording the one or more wagers;
wherein, after occurrence of the one or more sporting events results in a series of winning outcomes, the first computer server (i) determines whether the series of randomly generated symbols on each ticket matches the series of winning outcomes, and if so, determines an amount of a payout from the one or more wagers via communication with the second computer server that manages the one or more wagers, and (ii) if the series of randomly generated symbols on each ticket matches the series of winning outcomes, also determines whether the player further qualifies for a progressive payout from the progressive pool.

7. The system as recited in claim 6, wherein, after occurrence of the one or more sporting events results in the series of winning outcomes, the first computer server also (iii) determines whether any consolation prizes are to be awarded, and if so, accesses the secondary payout pool to pay such consolation prizes.

8. The system as recited in claim 6, wherein, after occurrence of the one or more sporting events results in the series of winning outcomes, the first computer server also (iii) determines whether the amount of the payout from the one or more wagers exceeds a predetermined minimum amount, and if not, uses the secondary payout pool to supplement the payout from the one or more wagers, resulting in a final payout.

9. The system as recited in claim 6, wherein the symbols are alphanumeric characters.

10. The system as recited in claim 6, wherein the symbols are numbers.

11. The system as recited in claim 10, wherein each point-of-purchase terminal includes a software-implemented random number generator that generates the series of randomly generated symbols for each ticket.

12. A method for wagering on one or more sporting events, comprising the steps of:
generating a ticket at a point-of-purchase terminal for a player that includes a series of player-selected symbols or a series of randomly generated symbols, each symbol corresponding to a selected outcome associated with each of the one or more sporting events, wherein the ticket is acquired for a purchase price;
recording the generation of the ticket at a first computer server in communication with the point-of-purchase terminal;
allocating a first portion of the purchase price to a wager on the selected outcomes and placing the wager in the amount of the first portion of the purchase price with a sportsbook via communication between the first computer server and a second computer server hosted by the sportsbook;
allocating another portion of the purchase price to a progressive pool;
determining, after occurrence of the one or more sporting events results in a series of winning outcomes, and using the first computer server, whether the series of player-selected symbols or the series of randomly generated symbols on the ticket matches the series of winning outcomes, and if so, determining, using the first computer server, an amount of a payout from the wager via communication with the second computer server hosted by the sportsbook; and
determining, after occurrence of the one or more sporting events results in the series of winning outcomes, and using the first computer server, whether the player also qualifies for a progressive payout from the progressive pool.

13. The method as recited in claim 12, and further comprising the step of allocating yet another portion of the purchase price to a secondary payout pool.

14. The method as recited in claim 13, and further comprising the step of:
determining, after occurrence of the one or more sporting events results in the series of winning outcomes, and using the first computer server, whether any consolation prizes are to be awarded, and if so, accessing the secondary payout pool to pay such consolation prizes.

15. The method as recited in claim 13, and further comprising the step of:
determining, using the first computer server, whether the amount of the payout from the wager exceeds a predetermined minimum amount, and if not, using the secondary payout pool to supplement the payout from the wager, resulting in a final payout.

16. The method as recited in claim 12, wherein the wager comprises a series of individual wagers, one associated with each symbol included on the ticket.

17. The method as recited in claim 12, wherein the symbols are alphanumeric characters.

18. The method as recited in claim 12, wherein the symbols are numbers.

19. The method as recited in claim 12, wherein the point-of-purchase terminal is a user device.

20. The method as recited in claim 19, wherein the user device is a smartphone, a tablet, a desktop computer, or another computing device.
